(19) United States
(12) Patent Application Publication
(10) Pub. No.: US 2015/0249624 A1
(43) Pub. Date: Sep. 3, 2015

(54) Process and method for expanding reply capabilities within a computer implemented messaging thread network.

(71) Applicants: Robert Alan Hilborn, II, Wyncote, PA (US); Stephen Anthony Hilborn, Shoemakersville, PA (US); Eric Raymond Hilborn, Wyncote, PA (US); Ralph Warren Hilborn, III, Perkasie, PA (US)

(72) Inventors: Robert Alan Hilborn, II, Wyncote, PA (US); Stephen Anthony Hilborn, Shoemakersville, PA (US); Eric Raymond Hilborn, Wyncote, PA (US); Ralph Warren Hilborn, III, Perkasie, PA (US)

(21) Appl. No.: 14/632,968

(22) Filed: Feb. 26, 2015

Related U.S. Application Data
(60) Provisional application No. 61/945,915, filed on Feb. 28, 2014.

(51) Int. Cl. H04L 12/58

(52) U.S. Cl. CPC H04L 51/02; H04L 51/16

(57) ABSTRACT

A computer implemented messaging process that expands reply capabilities and employs functions for propagating and referencing content data in a messaging network is described. The invention expands comment replies to a special tier of nesting that renders replies to replies as subordinate initial content, which can extend from any nested replies in the network. Furthermore, the process includes functions for transforming special tier content into stand-alone content and special tier content-referencing that allows special tier content to be attached onto any and all existing content in the network.

### CROSS REFERENCE TO RELATED APPLICATIONS

The application claims the benefit of a provisional application for utility patent application No. 61/945,915 filed on Feb. 28, 2014

### STATEMENT OF FEDERALLY SPONSORED RESEARCH OR DEVELOPMENT

Not Applicable

### NAMES OF THE PARTIES TO A JOINT RESEARCH AGREEMENT

Not Applicable

### REFERENCE TO A “SEQUENCE LISTING”

Not Applicable

### BACKGROUND OF THE INVENTION

The present invention relates to the field of Internet based computer implemented messaging processes for text-based group communication. For the purposes of this patent application, a group communication messaging process software includes any form of group communication messaging process software including without limitation blogs, forums, chat rooms, message boards, threads, social media, social networking, wikis, instant messengers, text messaging, posting, and publishing software and applications.

It is known in the art to provide group messaging applications for individuals to express ideas, collaborate with others, accomplish team goals or objectives, or to seek information. These systems generally host user-created accounts and store user-generated content for reference. In some cases, the processes identify user expertise or rank based on feedback from other users or metrics of specific user activity.

The limitations of the known art are: (a) Static Organization—there exists no organic process for replying to specific content posted by users on a messaging application. In a thread, users have adopted a method of reposting the entirety of another user's content in order to identify their following content as a reply, thereby creating difficulties in tracking the conversation by cluttering the main conversation space with replies. Additionally, there exists no method for replying to replies in such a way that directs conversation toward ancillary topics or focuses replying specifically toward certain users and/or content; (b) Limited Functions—the existing functions are limited to publishing, posting, replying and rating. These limitations do not allow for exponential growth of content or cross content collaboration.

### BRIEF SUMMARY OF THE INVENTION

An objective of the present invention is to provide a community of users with a platform for publishing user created content, interacting with other users, and collaborating to accomplish goals. A quality of the present invention that is unique to the art is the ability for the conversation space to grow by a number of dynamics: (1) the special tier reply, (2) the ability to transform an existing special tier reply and its subsequent content into a new thread, and (3) the ability to copy and paste content across multiple threads. Furthermore, special tier replying is a process by which users are able to respond to specific user content in the same fashion as an aside during an interpersonal conversation. Rather than cluttering the main line of a thread's conversation space with asides, the function of the special tier reply creates a more logical dynamic for the purpose of specific or exclusive replying. The second reply function described furthermore comprises the process by which users are able to perpetuate special tier reply content and its subsequent content and take it under administrative control. The third function described furthermore comprises the process by which users are able to copy content and insert it into another location within the same thread or within another thread.

Additionally, an objective of the invention is to foster collaboration and brainstorming in groups. The functions of the messaging process allow for dynamic group communication. Users can engage in multiple smaller ancillary conversations that originate from the core topic of the initial thread content. Individuals with different areas of expertise or varied frames of reference can collaborate more effectively using this messaging process.

### BRIEF DESCRIPTION OF THE SEVERAL VIEWS OF THE DRAWINGS

FIG. 1 shows a flow diagram of the process for creating the functions of the messaging system detailing an embodiment of the present invention.

FIG. 2 shows a basic data model of the reply functions as they appear as data structures in the messaging system.

### DETAILED DESCRIPTION OF THE INVENTION

The invention consists of three unique data structuring avenues for dynamic reply functionality in a text based messaging network. The first avenue consists of the ability for reply content to occupy a special tier of nesting that exists as an ancillary response nested aside the content it is in response to. This tier of nesting is treated as both a nested response and as the initial content of a sub-thread. The special tier nested reply may also be replied to in the same nesting fashion as an initial content post, and the subsequent responses may also produce special tier nested replies, so on and so forth, without limitation. The reply data is structured in such a way that it does not obstruct the conventional nested reply structure of the initial content, but rather multiplies the potential for the propagation of ancillary reply content (replies to replies).

The second avenue depends directly upon the special tier nested reply function. Special tier nested reply content does not exist independently from the thread reply data it issues from, unless it is initiated by a user to be published as a stand-alone piece of initial content. The user may manually identify a special tier nested reply and transform it into the initial content of a new thread, wherein the nested replies and subsequent special tier replies are cut from the original thread and published with a new user-generated title and topic as a new thread.

The third avenue consists of special tier reply content that already exists in the system. The user may designate that a special tier reply (and its subsequent reply content) be copied to a content clipboard and from there, be attached as reply content to another reply in the system. The copied content may only be posted as a special tier reply and not as a traditional nested reply.

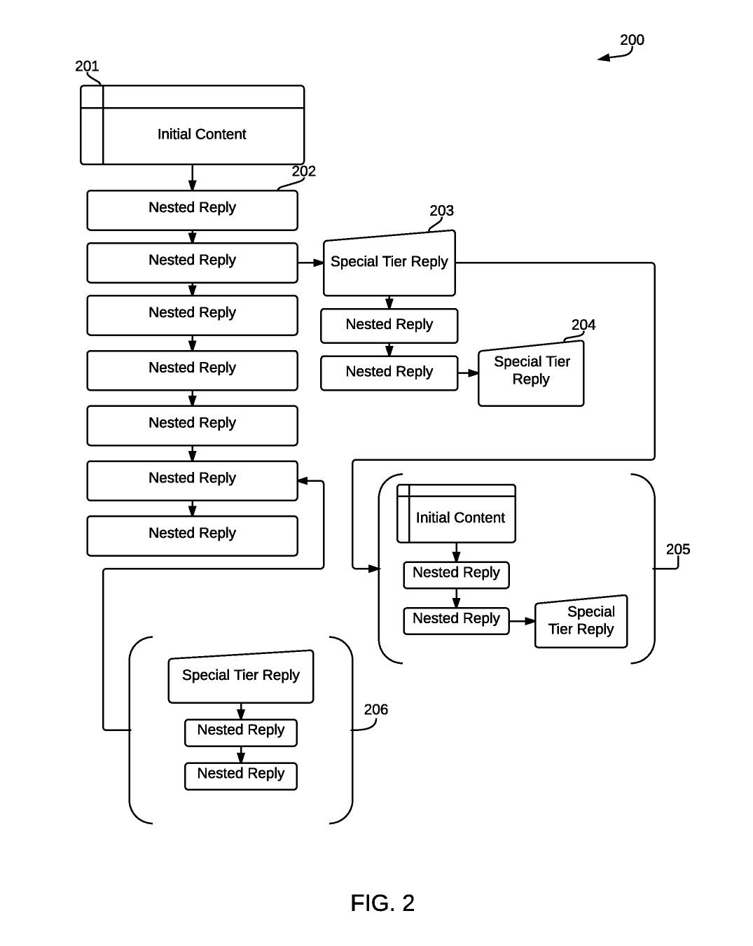

FIG. 2. shows a basic data model illustrating the relationships between the three unique avenues of reply functionality and the conventional nested reply structure. The conventional nested reply structure 200 consists of the initial content 201 or first published message by a user, and the nested reply 202. All elements labeled “Nested Reply” are all intended to be represented by 202. Initial content 201 is generated by the user with input data such as title, topic, tags, and text content. Nested replies 202 consist of any reply data to the initial content by the same or other users, proceeding in chronological order by time stamp. Note that the arrows in this model are intended to illustrate president, not flow. A vertical arrow (down) illustrates a reply that follows another reply to the above initial content, and horizontal arrows represent the same, but for this special case, the special tier reply 203.

Special tier reply 203 represents the special function of ancillary reply capability. The special tier reply 203 can issue from any nested reply 202. Any number of special tier replies 203 may originate from one nested reply 202. Any replies regarding the content published in the special tier reply 203 are nested accordingly as though special tier reply 203 were initial content 201, producing nested replies 202 subordinate to special tier replies 203. Special tier reply 204 illustrates the principle that subordinate replies to the first level of special tier reply 203 may also consist of special tier replies 204 and onward in that fashion without limitation.

Special tier reply 203 also represents an embodiment of the special tier reply 203 that produces an initial content 205. Initial content 205 is the result of a user function in which a special tier reply 203 and any subordinate nested replies 202 or special tier replies 203 are cut from the conventional reply structure 200 and published as a new conventional reply structure 200 (hence the parenthesis).

Special tier reply 203 represents an embodiment of the special tier reply 203 that produces a special tier reply data structure 206. Special tier reply data structure 206 is the result of a user function in which a special tier reply 203 and any subordinate nested replies 202 or special tier replies 204 are copied from elsewhere in the network (hence the parenthesis) and attached to an existing nested reply 202 as a special tier reply 203.

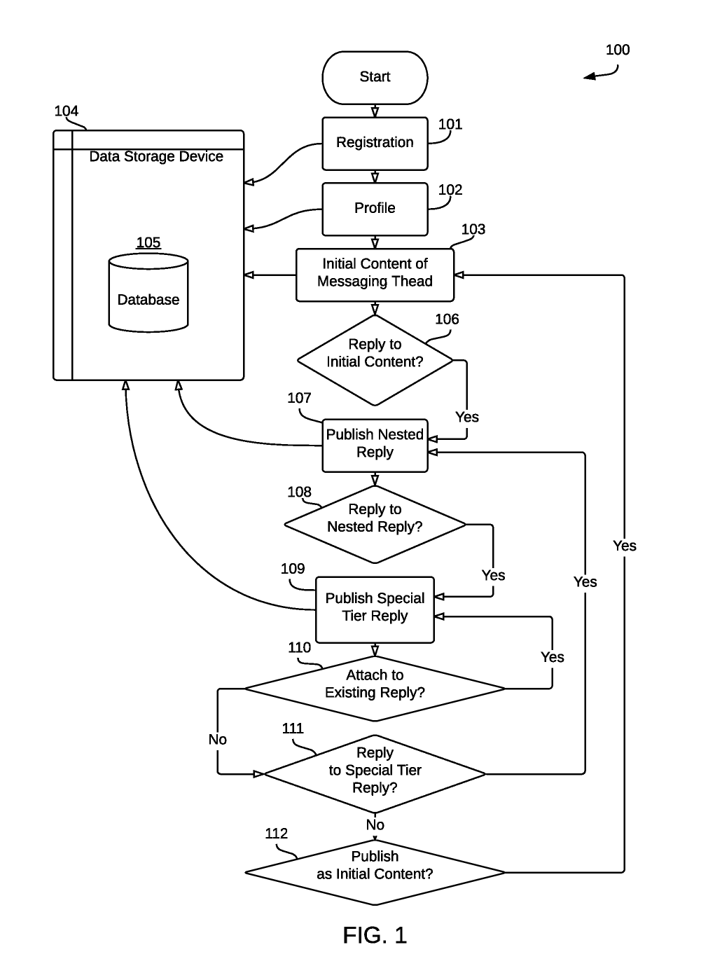

FIG. 1 is a flow diagram of the process for the messaging network's reply system. The process 100 illustrates the logic pathways when assigning relationships between various pieces of data in the data structure. “Start” represents both the beginning of the process and the point of entry for a user. Registration 101 embodies the process for a user first entering the network. Typically, registration consists of a user providing a conformation address (email) and the system assigning a user ID to that specific user, which, in the case of this process, is considered a standard practice in the art. Profile 102 is also a standard practice and consists of the user providing more detailed information and customizing their experience. The system logs any relevant user data entered in both the registration 101 and profile 102 process steps into a database 105 stored in a data storage device 104.

Initial content of a messaging thread 103 initiates the start of the messaging application. In 103, a user publishes the first message, or initial content of a messaging thread. This thread is treated as a forum, in which the user who creates the initial content determines the title, topic, tags, and invitations for the messaging thread. The initial text content is then entered by said user, and the message thread 103 is published. The content entered in 103 is also entered into a database 105 stored in a data storage device 104.

A decision step for the logic of the system is represented in 106. Should another user reply to the initial content of the published thread, the content shall be published as a nested reply 107. Nested reply 107 is the first and only option for decisions in this stage of the messaging system matrix. Replies to initial content 103 shall continue to nest in conventional fashion, proceeding in chronological order by time stamp. Decision 108 occurs when a user replies to any nested reply 107 of the initial content 103. If “yes”, than special tier reply 109 is published.

Special tier reply 109 is published as ancillary content to the conventional messaging system reply matrix. The following decisions 110, 111 and 112 are dependent upon user functionality. Should a user decide to attach an existing special tier reply to another nested reply in the system, the decision 110 illustrates that the system treat the content as a special tier reply. Decision 111 represents when a user replies to the content of a special tier reply 109, that the reply be treated as a nested reply 107. Decision 112 represents when a user transforms a special tier reply 109 into a new thread. Note: the pathways of the decision matrix illustrate the propagation of ancillary content, meaning that the decisions may continue to redirect any number of times up the structure. All content published by users following any decision on the application is entered into a database 105 stored in a data storage device 104, as is customary in the art.

The invention claimed is:

1. A computer implemented messaging process and method comprising: a. at least one data storage device comprising a database stored in a memory; b. the messaging system assigning code identifications to users and input in order to identify the user/input as either: 1. an administrator (user), title, topic and initial content for publishing a message board/thread, 2. a user and a reply to an initial content published, and 3. a user and a special tier reply, wherein the special tier reply is identified as both a reply to the initial content of the thread and an initial content for a subordinate thread issuing from the reply; c. the messaging process implementing a method wherein a user may designate a special tier reply as an independent thread published with a new topic and title, wherein the user whose reply was made initial content is administrator, and wherein any and all replies and any and all special tier replies having been posted previously are cut from the original thread and published into the new thread; and d. the messaging process implementing a method wherein a user may copy a reply to an initial content (or special tier reply) to a clipboard. The content copied to the clipboard can be attached to a different thread or another part of the same thread, wherein any and all replies and any and all special tier replies having been posted previously are copied from their original location and published in the new location, wherein the user may identify the copied content as either a reply to initial content or a special tier reply to any content in a different location in the same thread or in any other location in another thread.

2. A messaging process as recited in claim 1, wherein the title, topic and any and all subtopics are assigned manually by a user/administrator.

3. A messaging process as recited in claim 1, wherein any key words referring to the topic or content of a forum are assigned manually by a user/administrator.

4. A messaging process as recited in claim 1, wherein a reply to a special tier reply may also be designated as a special tier reply, and furthermore in such fashion without limitation.
